(19) United States
(12) Patent Application Publication
(10) Pub. No.: US 2008/0115193 A1
(43) Pub. Date: May 15, 2008

(54) Method And System For Managing Patient's Identities Of A Computer Network Producing And Storing Medical Data

(75) Inventors: Laurent Prax, Mimet (FR); Yannick Kereun, Aix En Provence (FR)

Correspondence Address: YOUNG & THOMPSON, 209 Madison Street, Suite 500, ALEXANDRIA, VA, 22314, US

(73) Assignee: GRED, Paris (FR)

(21) Appl. No.: 11/813,379

(22) PCT Filed: Dec. 2, 2005
(86) PCT No.: PCT/FR05/03019

§ 371 Date: Jul. 26, 2007

(30) Foreign Application Priority Data
Jan. 4, 2005 (FR) 05 00044

(51) Int. Cl. H04L 9/32

(52) U.S. Cl. 726/2

(57) ABSTRACT

A method for managing patients' identities of a computer network producing and storing medical data concerning the patients and referenced on the network by the latter's identities includes the following steps: searching on the network for the identities potentially associated with a common patient; validating (208) at least one found identity as being actually associated with the patient; selecting (214) an identity among the validated identities; and merging under the selected identity at least another validated identity, such that the at least one other identity merged is put offline, and that the data concerning the patient previously referenced by the at least one other merged identity are presently referenced by the selected identity of the patient.

The present invention relates to a method and a server for managing patients' identities in a computer network producing and storing medical data relating to said patients and referenced on the network by the identities of said patients.

Typically, a patient's medical computer data, generated during different medical acts on said patient, are stored on a plurality of data servers. Indeed, each medical organisation, such as a hospital, radiological clinic, geographical grouping of health practitioners, etc. has its own computer hardware for storing data. Moreover, each medical organisation may generally use its own computer format for referencing a patient, such that several patient identity formats are used.

In addition, it may be that for the same medical organisation, a plurality of identities for the same patient are active, owing, for example, to the creation in error of multiple identities for said patient.

Thus, a single computer identity by medical organisation does not necessarily exist for a patient. In addition, a medical operator who wishes to access diverse medical data for a patient must then carry out a cross-check to determine what data stored on different servers are effectively associated with said patient or must have all said patient's identities available. Moreover, the medical operator may fail to consult important medical data because it is not referenced under an identity known to the operator.

The problem of multiple identities for the same patient is also present between different medical organisations. Indeed, because one identity per medical organisation may exist for each patient, an operator is faced with the aforementioned problem when he wishes to consult the patient's medical data stored on the servers of different organisations.

The object of the invention is to solve the aforementioned problems by proposing a patient identity management server suitable for managing the patient identities referenced on a computer network producing and storing medical data so as to obtain a unique identity per patient on said network.

Accordingly, the invention relates to a method for managing patient identities in a computer network producing and storing medical data relating to said patients and referenced on the network by the identities of said patients, characterised in that it comprises:

a search step on the network for identities potentially associated with the same patient;

a validation step of a least one identity found to be effectively associated with said patient;

a step for selecting an identity from among the validated identities; and

a step for merging at least one other validated identity under the selected identity, such that this at least one other merged identity is taken offline, and such that the data relating to this patient previously referenced by this at least one other merged identity are now referenced by the selected identity of said patient.

According to particular embodiments, the method comprises one or a plurality of the following characteristics:

the patient's identity comprises a plurality of alphanumeric identification fields for said patient, and the search step comprises:
a step for selecting at least one set of identities from the network depending on a first predetermined field and/or a predetermined partition of the network into computer sub-networks;
a step for selecting two identities from the selected set;
a step for comparing these two identities suitable for comparing the values of at least one second field thereof; and
a step for creating a logical relation between these two identities if they have a degree of similarity greater than a predetermined value, this relation defining them as identities that are potentially associated with the same patient.

the plurality of identification fields of a patient's identity comprises character strings relating respectively to the surname, forename, date of birth and sex of the patient and the comparison step of the two identities comprises the implementation of a phonetic-comparison-type algorithm between, on the one hand, the surnames of these two identities, and, on the other hand, the forenames of these two identities, and:
if the surnames and forenames of these two identities correspond phonetically, and the sex and date of birth thereof are identical, the two identities are then ascertained as having a high degree of similarity;

if only the surnames of these two identities correspond phonetically, and the sex and date of birth thereof are identical, the two identities are then ascertained as having a moderate degree of similarity; and
otherwise, these two identities are ascertained as having a low degree of similarity;

the plurality of identification fields for a patient's identity comprises character strings relating respectively to the surname and forename of the patient, the comparison step of the two identities comprises the implementation of a divergence-type algorithm between, on the one hand, the surnames of these two identities, and on the other hand, the forenames of these two identities, and to ascertain the degree of similarity between them depending on the average divergences between the surnames and forenames returned by the divergence-type algorithm;

it comprises a step for creating a logical link between two identities in the network;

it comprises a merger cancellation step between two identities on the network, the merged identity being then put back online and the medical data referenced by these identities being restored to their initial state;

it comprises a search step, by a medical operator or external third-party system, for a patient identity in the network by interrogating the value of at least one identification field of the identity;

a patient's identity on the network comprises a plurality of identification fields distributed in sets of identification fields, in particular an identifier field referencing in a one-to-one manner on the network the patient associated with the identity and properties relating respectively to principal, secondary, complementary and administrative identification data for that identity; and

when an identity in the network is modified, all the computer resources in the network using this identity are notified thereof in order to update said identity on said computer resources.

The invention also relates to a server for managing patients' identities in a computer network producing and storing medical data relating to said patients and referenced on the network by the identities of said patients, characterised in that it comprises:

means for searching on the network for identities potentially associated with the same patient;

means for validating at least one identity found to be effectively associated with said patient;

means for selecting an identity from among the validated identities; and

means for merging at least one other validated identity under the selected identity, such that said at least one other merged identity is taken offline, and such that the data relating to said patient previously referenced by said at least one other merged identity are now referenced by the identity selected for said patient.

According to other characteristics:

the server is suitable for implementing the aforementioned type of identity management method;

it comprises trace storage means for storing data relating to accesses to the server and the functions thereof;

it comprises means for generating statistics depending on data stored in the means over a predetermined time period in the trace storage means;

it comprises means for authenticating a user connected by a terminal; and

it comprises means for allocating to the user authorisations from a predetermined set of authorisations relating to the use of functions and access to data on the server.

The invention also relates to a patient identity reconciliation method for a plurality of computer networks producing and storing medical data relating to said patients, characterised in that it comprises:

a step for creating a unifying identity for a patient identified in the plurality of networks;

a search step on the plurality of networks for identities potentially associated with this same patient;

a step for validating an identity found to be effectively associated with this same patient; and

a step for reconciling the validated identity under the patient's unifying identity.

According to other characteristics,

it comprises a step for modifying a unifying identity and notifying at least one server from the plurality of networks using the unifying identity that said unifying identity has been modified;

the search step comprises a step for selecting an identity from the plurality of networks;

the identities from the plurality of networks are controlled by computer servers, and the search step comprises an identity search notification step for each of said servers depending on data relating to the patient stored in the unifying identity; and

the validation step comprises a step for comparing identities delivered by the computer servers in response to the search notification to said servers.

The invention also relates to a patient identity reconciliation server for a plurality of computer networks producing and storing medical data relating to said patients, characterised in that it comprises:

means for creating a unifying identity for a patient identified in the plurality of networks;

means for searching on the plurality of networks for identities potentially associated with the same patient;

means for validating an identity found to be effectively associated with the same patient; and

means for reconciling the validated identity under the patient's unifying identity.

According to another characteristic, the reconciliation server is also an identity server of the aforementioned type for at least one network of the plurality of networks.

The invention will be better understood on reading the description that follows, given purely by way of example, and produced in relation to the accompanying drawings, in which:

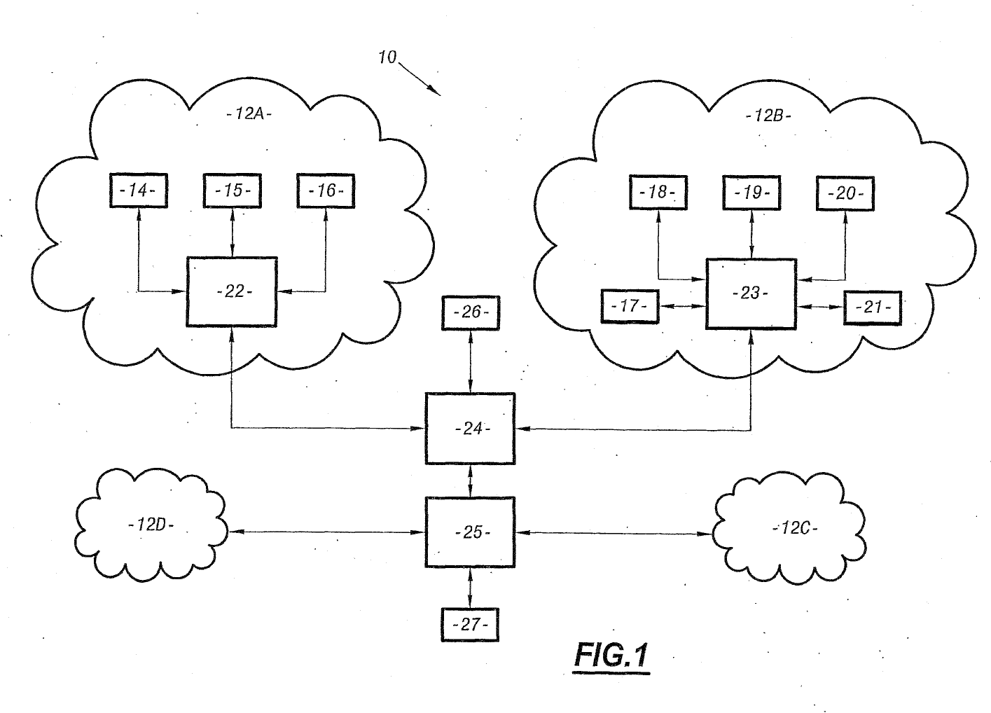

FIG. 1 is a schematic view of a computer network producing and storing medical data relating to patients and comprising an identity management server and a reconciliation server according to the invention;

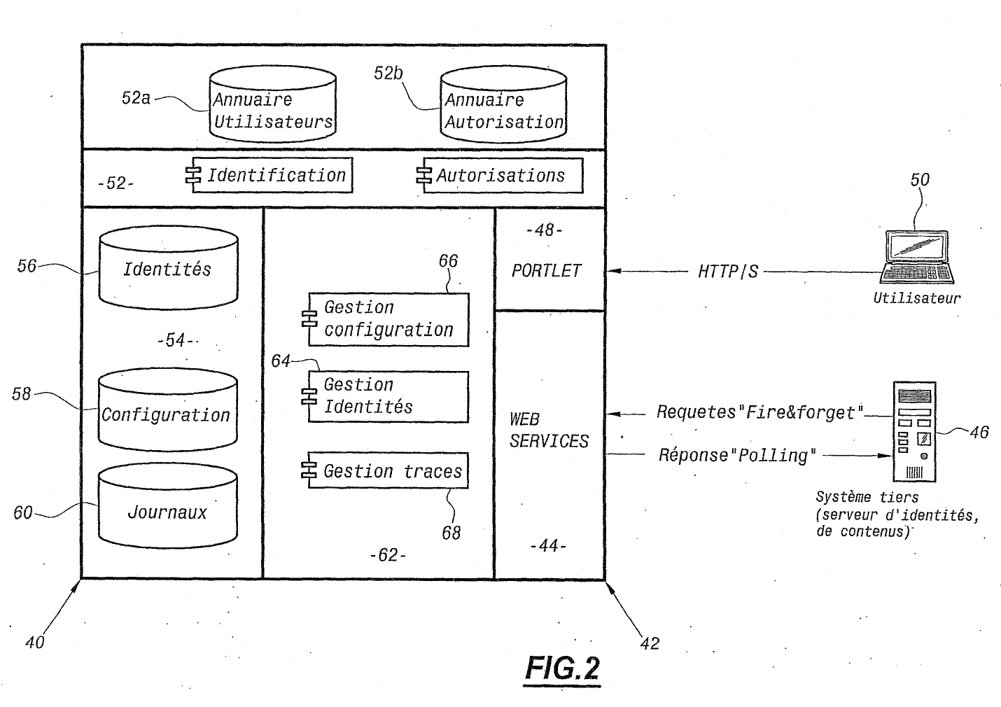

FIG. 2 is a schematic view in greater detail of an identity management server according to the invention;

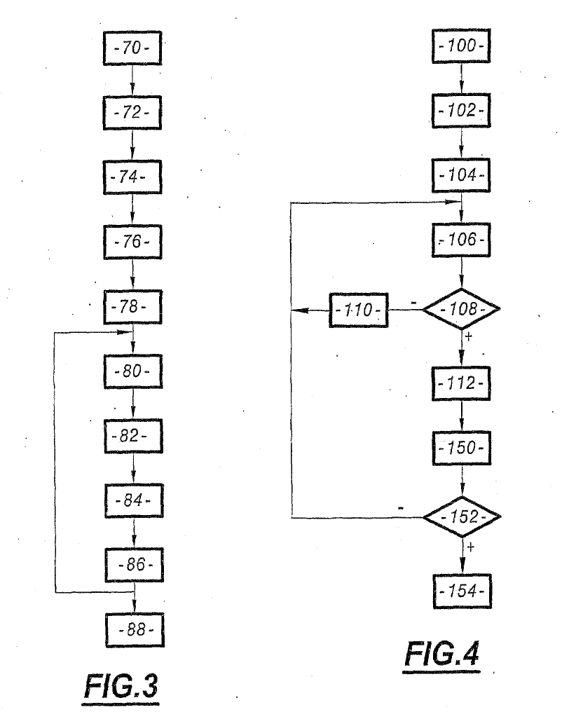

FIG. 3 is a functional flow chart for the identity management server in FIG. 2;

FIG. 4 is a functional flow chart for the duplicate identity search implemented by an identity management server according to the invention;

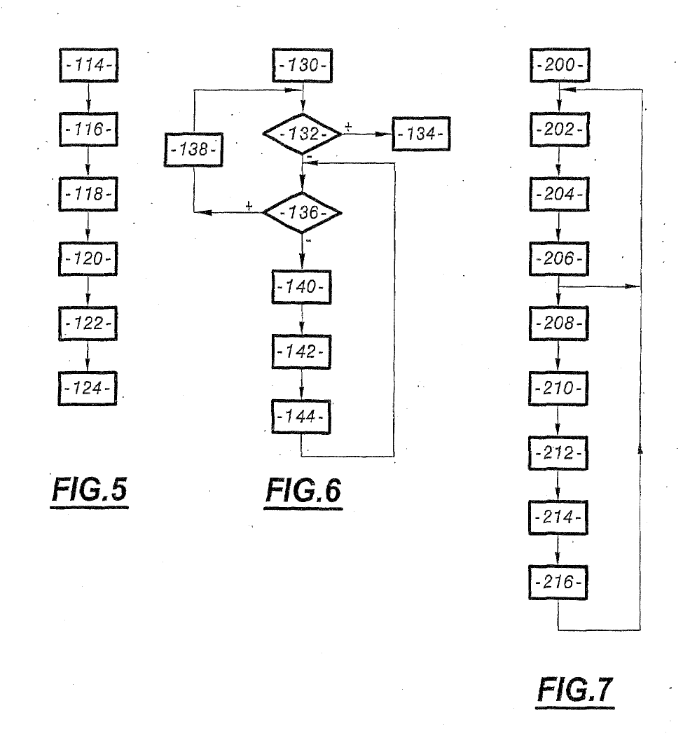

FIG. 5 is a flow chart of the steps of duplicate detection by phonetic-type comparison;

FIG. 6 is a flow chart of the steps of duplicate detection by divergence-type comparison;

FIG. 7 is a flow chart of the logical cancellation steps of an identity of an identity management server according to the invention;

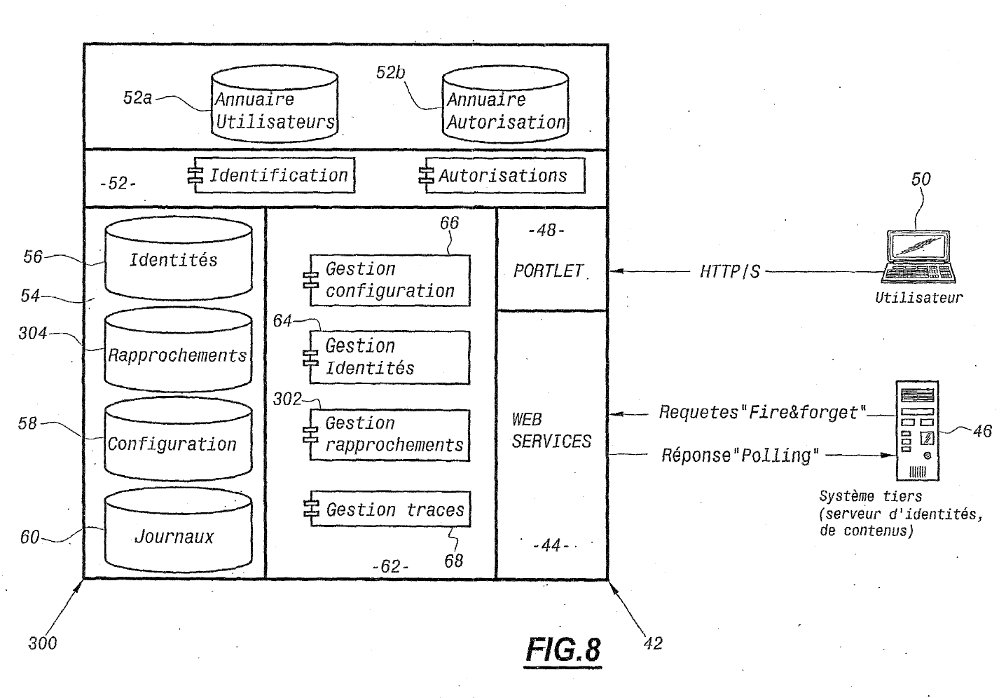

FIG. 8 is a view in greater detail of a reconciliation server according to the invention; and

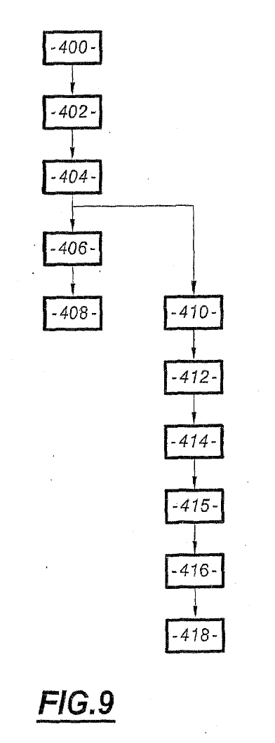

FIG. 9 is a functional flow chart for the reconciliation server in FIG. 8.

In FIG. 1, a computer network 10 producing and storing medical data relating to patients comprises a plurality of sub-networks 12A, 12B, 12C, 12D. Each sub-network 12A, 12B, 12C, 12D is, for example, an internal computer network for a medical organisation, such as a hospital, clinic, general practitioner, area hospital grouping, etc.

The sub-network 12A, 12B, 12C, 12D comprises one or a plurality of content servers 14, 15, 16, 17, 18, 19, 20, 21 storing in computer format patient medical data generated following medical acts on said patents, such as, X-rays, surgical reports, blood tests, etc. Each of the medical data relating to a patient is referenced in the sub-network 12A, 12B, 12C, 12D by a computer identity created and supplied by an operator authorised by the medical organisation. This identity is stored in an identity management server 22, 23 according to the invention connected to content servers 14-21.

This server 22, 23 is suitable for searching and for deleting duplicate identities, i.e. multiple identities associated with the same patient, and thus ensuring that a single identity for said patient is stored on the network 12A, 12B, 12C, 12D of the medical organisation. This single identity is then used by the content servers 14, 15, 16, 17, 18, 19, 20, 21 of said organisation for indexing the patient's medical data, stored by said servers.

Although an identity management server is shown separate from the content servers, it will of course be understood that the identity management server may also be a content server.

Similarly, an identity management server is suitable for managing different sets, or internal domains, of patient identities independently, each of these sets being associated with a predetermined portion of the computer network.

Each identity management server 22, 23 can implement its own identity administration rules. For example, rules for naming patients, identity format definitions or different levels of confidentiality may be used.

Moreover, it may be necessary, for reasons of security, for example, for medical organisations to be equipped with their own respective identity management servers, such that patient identity management is not implemented centrally.

Advantageously, the network 10 is provided with at least one reconciliation server 24, 25 connected to a plurality of identity management servers 22, 23. The reconciliation server 24, 25 can also be connected to one or a plurality of other reconciliation servers 24, 25. Such a reconciliation server 24, 25 is suitable for indexing under a single unifying identity the identities of a patient stored in the identity management and reconciliation servers connected thereto.

All the identities managed by a third-party server external to the reconciliation server 24, 25 are defined as being in the external domain for that server and all the identities that the server 24, 25 reconciles by indexing them under the unifying identities that it stores are defined as being in the reconciliation domain for that server.

The reconciliation server 24, 25 receives messages from each identity management and reconciliation server connected thereto. This external server notifies the reconciliation server 24, 25 regularly of relevant activity, i.e. of identity management and administration operations, as will be explained in greater detail below.

An external server also communicates with the reconciliation server 24, 25 to search for and consult unifying identities.

Preferably, the reconciliation server 24, 25 does not differentiate operationally between an identity management server and a reconciliation server. It communicates in an identical manner with these two types of server and performs the same services for them.

Since the reconciliation servers 24, 25 can be connected to one another to reconcile their respective reconciliation domains, it will be understood that gradually the reconciliation servers according to the invention allow a single identity to be obtained for each patient on any geographical or organisational scale, for example at local, regional or national level or at the level of all teaching hospitals, dental practices, etc. depending on their location in the computer network 10.

Although a reconciliation server is shown here as a separate computer entity, in a variant, a reconciliation server may also be suitable for implementing the functions of an identity management server for the network of a medical organisation.

All the identities that it manages as an identity management server are referred to as an internal domain. Of course, said internal domain participates in the reconciliation domain of the server, i.e. the reconciliation server reconciles its internal domain with its external domains.

Finally, an authorised user can connect to each of the identity management or reconciliation servers by a terminal 26, 27 as will be explained in greater detail below.

FIG. 2 is a view in greater detail of an identity management server 40 according to the invention.

The server 40 comprises a communication interface 42 with third parties. This interface 42 comprises a communication interface 44 with each external content server 46 for which it manages patient identities and each reconciliation server reconciling the identities of the server 40 and/or the identities of which are reconciled by the server 40.

The interface 42 also comprises a user interface 48 for communicating with each user connected to the server 40 by means of a terminal 50.

Preferably, the identity management server 40 and the external servers 46 use a data communication protocol based on notifications and requests/responses, of the HL7 XML type, for example, and the communication interface 44 is an application service of the Web service type.

Preferably, the server 40 and a user terminal, or an external server, communicate by SOAP using a secure transport layer of the SSL type, for example. The user accesses the server 40 by means of a light client application, such as a web browser for example, and the user interface 48 is a portlet-type application.

The user interface 48 is associated with an authorisation and authentication application 52 to control user access to the server 40 and to all its functions and the data stored in it. This application 52 is associated with a relational database of users 52a, or user directory, which lists user authentication data, such as identifiers, passwords and digital certificates for example. The application 52 is also associated with a database 52b of access authorisations to the functions and data on the server 40. This database 52b lists the predetermined authorisation data for each user listed in the database 52a, as will be explained in greater detail below.

The server 40 also comprises data storage means 54 comprising a database 56 storing patient identities, a database 58 storing data relating to the configuration of the server 40 and a database 60 forming a trace log storing information relating to accesses to the server 40 by third parties and the types of operations performed by those third parties.

The server 40 comprises a set of applications 62, a first application 64 implementing identity management functions, a second application 66 implementing functions for configuring the over 40 and a third application 68 implementing functions for managing traces of accesses to the server 40.

An identity stored in the identity database 56 comprises a plurality of identification fields, in particular a principal identifier, a set of properties describing the patient and defining the identity administration rules and a general identity status flag.

The principal identifier references the identity singly and in a one-to-one manner in the internal domain of the server 40, i.e. on the computer network for which it manages patient identities.

The properties comprise a dataset describing the patient's profile for identification thereof, in particular alphanumeric fields such as the patient's “surname”, “forename”, “sex”, “location”, “date of birth”, ”pseudonym”, etc.

These properties are distributed among the principal properties defined as necessary for patient identification, secondary properties defined as not necessary and complementary properties that can only be accessed by authorised care staff, such as a doctor for example.

Each property is associated with a property status flag, which may take the value “provisional” if the data contained in the property is not certain, “validated” if the data is certain or “blank” if no data is contained in the property.

Administration properties define the way in which the identity is administered by the server 40 (anonymity, confidentiality, relevant information, default identity processing method depending on the general flag and the profile property flags, etc.).

The properties also comprise a set of fields to describe any possible logical links with other patient identities in the identity database 56, in particular a “duplicate” field, a “relationship” field and a “homonym” field, as will be explained in greater detail below. A logical link field comprises, for example, the identifier for an identity, so that it is possible to access an identity via its logical link with another identity.

The general status flag determines the general state of the identity. This status may be “active”, i.e. the identity is on line, “slave”, i.e. the identity is dependent on another identity associated with the same patient, “blank”, i.e. at least one of the principal properties has not been supplied, “provisional”, i.e. at least one of the principal properties has a provisional status and “offline”, i.e. the identity is not used for indexing medical data.

FIG. 3 is a flow chart of the principal steps of the identity management method implemented by the identity management server 40.

In a step 70, a user, such as a medical operator or doctor for example, sends a connection request to the identity management server 40 via a web browser installed on the computer terminal 50 connected to the server 40.

In reply, the server 40 sends a user authentication request at 72, for example by displaying a window asking for an identifier and a password to be input.

The user inputs his identifier and password at 74, and all this is notified to the server 40 by activating a button provided for this purpose on the input request window.

In a variant, the server 40 also requires a digital certificate for high-level user authentication. This digital certificate is for example generated by a PKI-type algorithm using a private key, and is stored in a chip card. The terminal of the user is equipped with a chip card terminal and, at the time of the authentication request, the reader reads the certificate contained in the card and notifies it to the server 40.

At 76, the server receives this data and activates the authentication and authorisation application 52. Said application compares the data received to the data contained in the user database 52a to authenticate the user.

If the user is authenticated by the identity management server 40, the connection is opened and initialised. A predetermined set of access authorisations to the functions and data on the server 40 is then allocated at 78 to the connection. For example, a Java application is executed on the terminal of the user displaying a window listing the functions and data types on the server 40 which the user is authorised to use or consult.

At 80, the user deals with this window using a function of the server 40 to which he has access and wishes to use.

During the following step 82 in the operation of the server 40, the application relating to the function selected is activated and a data exchange is established, if required by the finction, between the user and the server 40.

More particularly, the functions implemented by the server 40 by means of the aforementioned applications accessible to a user, under the aforementioned authorisation conditions, are in particular the:
creation of an identity: at the request of the user, the identity management application 64 creates an identity in the identity database 56 and attributes to it a principal single identifier in the internal domain of the server;
modification of an identity: at the request of the user, the application 64 modifies one of the properties or one of the statuses thereof;
creation and deletion of a logical link between identities: at the request of the user, the application 64 creates or deletes a logical link between two identities;
search for duplicate identities;
merge and merge cancellation between identities;
physical deletion of an identity: at the request of the user, the application 64 physically deletes an identity from the identity database 56;
multicriteria identity search; at the request of the user, a search window is displayed on the terminal 50. This window comprises for example fields for data input to search for identities, such as an identifier, surname, forename, etc. Advantageously, the application 64 comprises a search engine in the identity database 56. This identity database may be interrogated using a request-type interrogation protocol allowing the use of metacharacters such as asterisks, question marks and logical operators, as is known per se;
consultation of an identity: at the request of the user, the application 64 displays a predetermined profile of an identity which the user has selected, for example following a multicriteria search. The profile displayed is determined according to the authorisations of the user. For example, only the principal properties may be displayed, or alternatively the value of the “pseudonym” field of the identity is the only one displayed if the identity is confidential; and
search for a logical link between identities: at the request of the user, the application 64 displays on the terminal 50 a window comprising an identifier input field and an input field for the type of logical link sought. The user inputs the identifier of an identity and the type of link sought. These data are notified to the application 64 which, in return, delivers the data sought to the terminal 50.

Once the operations associated with the function have ended, if the function called has modified an identity stored in the identity database 56, i.e. has created an identity, modified the data contained therein, deleted it logically (i.e. taken it off line) or physically, the server 40 notifies at 84 the modifications made thereto to all the reconciliation and content servers using this identity that are connected thereto. In reply, these servers update their own identity databases.

The following step 86 activates the trace management application 68 which then updates the database 60 storing access information to the server 40, its functions and data. The application 68 records the identifier for example in this database and the time when the user accessed the server 40 and information relating to the different types of operation that he performed thereon, such as modification of an identity, a search for duplicate identities, modification of an administration rule for an identity, etc.

Step 86 then loops back to step 80 to call another function of the server or a closing step 88 of the session opened by the user is activated.

FIG. 4 is a flow chart for the algorithm implemented by the identity management application 64 to search for duplicate identities in the identity database 56.

In a step 100, a user who has opened a session under the identity server 40 via a terminal and has been authorised to use the duplicate identity detection function sends a duplicate identity search request to the server 40.

In reply, at 102, the server displays a parameter selection window for searching for duplicates on the terminal 50 of the user.

This selection window comprises in particular a field for selecting an internal domain of the server 40 and a field for selecting a duplicate detection mode from a predetermined set of detection modes, for example a phonetic-comparison-type detection mode and a divergence-comparison-type detection mode, which will be described in greater detail below.

Another field in the window allows the user, if he so wishes, to limit the search for duplicates to a predetermined set of patient identities, for example those for which the value of an alphanumeric field begins with a prefix input by the user.

Once the user has finished selecting duplicate search parameters, he notifies them, still at 102, to the server 40 by clicking, for example, on a button in the window provided for this purpose and the parameters selected in the fields of the window are then delivered, via the user interface 48, to the identity management application 64.

In a subsequent step 104, the application 64 initialises the search for duplicates by determining all the identities in the database 58 that match the domain and prefix selected by the user. Otherwise, the search for duplicates is performed on the entirety of the identities database 56.

In the next step 106, the application 64 selects a first and a second identity from the selected set that have not yet been compared.

In a subsequent step 108, in accordance with the administration rules of the server 40, the application 64 tests whether each of the selected identities meets the predetermined comparison conditions in order to be compared. For example, the application 64 may be configured to compare identities that are active and for which all the principal properties have been supplied and have a “validated” status.

In the embodiment described here, the application 64 tests whether the identities are active and whether their “surname” and “forename” fields have a “validated” status. If the phonetic-type detection method has been selected, the application 64 also tests whether the “sex” and “date of birth” fields have a “validated” status.

If the result of the test at 108 is negative, the application 64 determines, at 110, a low degree of similarity between the selected identities and loops to step 106 to select another pair of identities.

If the result of the test is positive, the application 64 continues its operation by comparing at 112 the first and second selected identities to determine a degree of similarity between them.

If the duplicate detection method selected by the user is of the phonetic comparison type, the application 64 then carries out a phonetic comparison of the alphanumeric field “surname” of the first and second identities and a phonetic comparison of the alphanumeric field “forename” of said first and second identities.

The phonetic comparison of two fields, for example the “forename” field, implemented by the application 64, consists initially of generating a phonetic code for each “forename” field of the first and second identities, as illustrated in the flow chart in FIG. 5.

In a step 114, the application 64 creates a character string for each “forename” field by duplicating the field then retaining the first letter of the string and then deleting the letters A, E, I, 0, U, Y, H and W from the string.

In a subsequent step 116, the application 64 replaces each remaining letter in the string created at 114, apart from the first, by a corresponding predetermined number, as described in Table 1, to generate a code.

TABLE 1
correspondence table between numbers and letters.

| | |
|---|---|
| 1 | B, P |
| 2 | C, Q, K |
| 3 | D, T |
| 4 | L |
| 5 | M, N |
| 6 | R |
| 7 | G, J |
| 8 | X, Z, S |
| 9 | F, V |

For example, the series of letters GRGR produced after deleting the letters E, 0 and Y from the chain GREGORY is replaced by the code G676.

In the next step 118, the application 64 eliminates the large number of identical numbers so as to generate a code comprising a single occurrence of each number. For example, the code G676 is replaced at 116 by the code G67. Preferably, the numbers farthest to the left are retained.

In the next step 120, if the code generated at 1 18 comprises fewer than N elements, where N is a predetermined number, for example equal to 4, the application 64 completes it by adding one or a plurality of zeros to the right so as to obtain a series of N elements. For example, the code G67 is completed to the right by adding one zero.

The next step 122 consists of selecting the N elements farthest to the left from the codes generated at 116 for each “forename” field of the identities to obtain a phonetic code for the forename.

In the following step 124, the application 64 determines a degree of similarity between the first and second identities depending on the phonetic codes determined at 122.

If the “surname” and “forename” fields of the first and second identities correspond phonetically, i.e. if their respective phonetic codes are identical, and their “sex” field or “date of birth” field respectively are identical, the application 64 then determines that there is a high degree of similarity between the two identities.

If only the “name” fields correspond phonetically and the “sex” fields and “date of birth” fields are identical, the identity management application 64 then determines that there is a moderate degree of similarity between the two identities.

In all other cases, the application 64 determines a low degree of similarity between the first and second identities.

Of course, identity fields other than the “sex” and “date of birth” fields may be used to determine the degree of similarity between two identities.

If the divergence-type duplicate detection method has been selected by the user, the application 64 determines the degree of similarity according to the “surname” and “forename” fields of the first and second identities, as illustrated in the diagram in FIG. 6.

In a first step 130 for determining the degree of similarity by divergence-type comparison, a matrix R is initialised for each pair of fields of the same type for the first and second identities, for example the “surname” fields.

This matrix comprises N rows and M columns, where N and M are the lengths of the values of the “surname” fields of the first and second identities respectively. The first line of the matrix R is initialised to the row vector [0 1 2 . . . N] and the first column of the matrix R to the column vector [0 1 2 . . . M]^{T}, where T is the symbol of the transpose.

At step 130 two counters i and j are also initialised to the value 0.

A test is carried out in a subsequent step 132 to find out whether the value of the counter i is equal to N+1. If the result of this test is positive, a divergence of similarity between the two “surname” fields is then determined at 134 as being equal to R(N,M).

If the result of the test is negative, a test is carried out at 136 to find out whether the value of the counter j is equal to M+1.

If the result of this test is positive, the counter i is incremented by 1 at step 138, which then loops to step 132.

If the result of this test is negative, a subsequent step 140 consists of comparing the i^{th} letter of the value of the “surname” field of the first identity with the j^{th} letter of the value of the “surname” field of the second identity. If these values are identical, the value of a variable c is set, at 140, to 0, and if they are different, the value of c is set to 1, still at 140.

The minimum of the values R(i−1,j)+1, R(i,j−1)+1 and R(i−1,j−1)+c is then determined and allocated to the value of R(i,j) in step 142.

In a subsequent step 144, the value of the counter j is incremented by 1 and the step 144 loops to step 136 for a new cycle.

An average divergence of similarity between the first and second identities is then calculated by the application 64 by producing the average of the divergences of similarity obtained for the “surname” and “forename” fields thereof.

The degree of similarity between the two identities is then determined by correspondence between the value of the average divergence of similarity calculated and a predetermined degree of similarity as described in Table 2.

TABLE 2
correspondence between the average divergence and the degree
of similarity.

| Average divergence | Degree of similarity |
|---|---|
| 0 | identical |
| 1 | high |
| 2 | average |
| 3 | low |

Implementation of one or other of the aforementioned duplicate detections allows identities potentially associated with the same patient to be searched for, one of which, for example, may comprise a spelling error in the patient's surname.

Referring once again to FIG. 3, the next step 150 of the operation of the identity management application 64 consists of comparing the determined degree of similarity with a predetermined threshold. For example, this threshold is equal to high, an identical degree of similarity being greater than a high degree of similarity, which is itself greater than a moderate degree of similarity, which in turn is greater than a low degree of similarity.

If the degree of similarity determined is greater than the predetermined threshold, the application 64, still at 150, creates a logical link between these two identities, i.e. a “potential duplicate” link. The application 64 accordingly sets the “duplicate” logical link field of the first identity to “potential duplicate” and writes the principal identifier of the second identity in this field. Similarly, the application 64 sets the “duplicate” logical link field of the second identity to “potential duplicate” and writes the principal identifier of the first identity in this field.

Thus, the first and second identities are determined to be potentially associated with the same patient and linked logically in the identity database 56.

In the next step 152, the application 64 tests whether all the identities from the set selected by the user have been compared.

If the result of this test is negative, step 152 loops to step 106 to select and compare a new pair of identities.

If the result of this test is positive, at 154 the application 64 displays the list of potential duplicates that it has determined on the terminal 50 of the user.

The flow chart in FIG. 7 illustrates the algorithm for deleting duplicate identities potentially associated with the same patient implemented by the application 64.

In step 200, a user who has opened a session in the identity management server 40 and has been authorised to use the identity duplicate deletion function implemented by the application 64, sends a duplicate deletion request to the server 40.

In response, at 202 said server sends a display window to the terminal 50 listing potential duplicates stored in the identities database 56, i.e. the pairs of identities connected by a “potential duplicate” logical link.

At 204, the user selects such a pair of identities and in response, at 206, the application 64 sends a window to the terminal 50 of the user displaying a predetermined profile for the patient associated with each of these identities, for example the values of the properties “surname”, “forename”, “sex”, “date of birth” and “address”.

The user then determines at 208 whether the two identities are effectively associated with the same patient. If this is not the case, the user sends a request to display the list of potential duplicates and step 208 loops to step 202.

If it is the case, still in 208, the user sends a request to amend the “potential duplicate” logical link to “validated duplicate”. In response, at 210, the application 64 modifies the identities by setting the “duplicate” field to “validated duplicate”. By setting the “duplicate” field of the identities to “validated duplicate” in this way, these identities are then determined to be effectively associated with the same patient.

The user, or in a variant the application 64, then selects, at 212, one of the identities as being a master identity and notifies it to the server 40.

In response, at 214, the application 64 sets the general status flag of the other identity to “slave”status and deactivates it. This identity is then taken offline and indexed under its master identity. The slave identity is thus merged under the master identity.

At 216, the server then sends a notification to each external third-party content and reconciliation system connected thereto that the identity has been deactivated and is now merged under the master identity. In response, these servers update their own identity databases.

Thus, the medical data previously referenced under the slave identity are now referenced under the master identity.

Step 216 then loops to step 202 to select new potential duplicate identities.

As can be seen, the identities associated with the same patient are gradually merged under a unique master identity. Thus, all the medical data relating to the same patient are referenced in the internal domain of the server 40 by a single identity thereof.

An authorised user may “demerge” two merged identities. At the request of the authorised user, the application 64 puts the slave identity back online in its initial state, i.e. in the state it was in before it was merged, and sets the “duplicate” field to “collision” to indicate that the identity is active again. The third-party servers are then notified that the identity has been put back online so that they can update their databases, and the medical data associated with this identity are therefore indexed once again by this identity.

The identity management server 40 can also regularly, periodically or at the request of an authorised user, generate statistics of a predetermined type. The trace management application 68 implements statistical calculations on the trace data stored in the trace database 60 over a predetermined time period, for example the last twenty-four hours, the last week, or another period. The calculations used by this application 68 relate for example to the number of accesses to the server, the type and number of operations carried out by and on the server, the type of data consulted and/or modified, modifications to identity administration rules, modifications to authentications and authorisations, or other operations.

The server 40 can also be accessed by each external content or reconciliation server connected thereto Such a server can deliver requests to search for and consult identities to which the server 40 responds by delivering the list of identities found or the identity consulted.

A description will now be given of a reconciliation server according to the invention in relation to FIG. 8.

In FIG. 8, a reconciliation server 300 is illustrated which is also an identity management server for content servers. It therefore shares common elements with the identity management server described in relation to FIG. 2. These elements are referenced in an identical way to those of the server in FIG. 2 and the description thereof will therefore be omitted here for reasons of conciseness.

The reconciliation server 300 therefore has an internal identity domain for which it implements identity management as an identity management server, an internal reconciliation domain made up of a set of identities, stored on identity management servers, which it unifies under its unifying identities.

The reconciliation server 300 comprises a reconciliation management application 302 implementing identity reconciliation functions, as will be explained in greater detail below. This reconciliation management application 302 is associated with a reconciliation database 304 which lists the unifying identities and associated reconciliations, as will also be explained in greater detail below.

The authorisation and authentication application 52 and the authorisation database 52b comprise supplementary authorisation data relating to the rights of users to use the functions of the application 302 and manipulations of the reconciliation data on the reconciliation database 304.

The format of the unifying identities is, for example, similar to that previously described for a patient's identity. The principal identifier of a unifying identity is created by the server so that it is unique in the internal reconciliation domain of that server.

The flow chart in FIG. 9 shows the operation of the server 300 as a reconciliation server.

In a step 400, a unifying identity for a patient, referenced in the reconciliation domain of the reconciliation server, is created by the reconciliation application 302 in the reconciliation database 304.

It may be created at the request of an authorised user connected to the server 302 in a similar way to the creation of an identity on the identity management server described in relation to FIG. 2. The user then fills in the fields of the unifying identity created with data relating to this patient.

Otherwise, the unifying identity may also be created by the application 302 in response to a request from an identity management or reconciliation server connected to the server 300. When a third-party server creates an identity for a new patient in its identity or reconciliation database, it notifies the reconciliation server 300 of this. The reconciliation server then checks whether the patient is already referenced by a unifying identity in the reconciliation database. If it is not, the reconciliation server 302 then creates a new unifying identity with the data delivered by the external server.

For example, the reconciliation application 302 is suitable for converting the patient's identity notified by the external server to the identity format used by the reconciliation server 300 by also attributing to it a unique identifier in its reconciliation domain.

During the next step 402, the reconciliation server 302 notifies the external servers of this creation.

In a subsequent step 404, a user connected to the server 302 sends an identity reconciliation request. A window is then displayed on the terminal of the user comprising a field for inputting the identifier of a unifying identity on the server and a field for inputting the identifier of an identity on an external server to be reconciled.

At 406, the user then inputs the identifiers of the two identities that he wishes to reconcile and validates his choice.

In response, the application 302 then creates a new reconciliation, at 408, in the reconciliation database 304. This reconciliation comprises the identifiers of the unifying identity and the reconciled identity such that the identity on the external server is indexed, or unified, under the unifying identity of the reconciliation server 300.

In a variant, the unifying identity may comprise supplementary fields listing the identifiers of the identities that it unifies.

It will be understood that what has just been described is also valid for the identities that the reconciliation server 300 manages as an identity management server. Indeed, the identity management and reconciliation services of the server 300 communicate between themselves to reconcile the identities stored in the identity database 56.

Advantageously, at 410 the user may, in a variant, search for identities potentially associated with the same patient in the internal or external domains of the reconciliation server 300.

This search is performed, for example, in a similar way to that of the search for duplicate identities described hereinbefore.

For example, at 412, the application 302 sends requests to search for and consult identities to the third-party identity and reconciliation servers depending on the data contained in a unifying identity, for example the values of the fields “surname” and “forename” of the unifying identity. At 414, the servers notified then implement a search in their respective identity or reconciliation databases for identities that match this data and deliver the identities found to the reconciliation server 300.

The reconciliation server 300 then implements the phonetic comparison-type or divergence- type algorithm and generates a list of identities potentially associated with the patient with the unifying identity.

The user then selects, at 416, one or a plurality of identities and validates each identity that he considers to be effectively associated with the patient with the unifying identity. In response, the server 302 then reconciles, at 418, the unifying identity and the validated identity as described hereinbefore.

In a similar way to that described hereinbefore, an authorised user may search for, consult, delete, modify or delete a unifying identity. He may also delete a reconciliation, consult all or part of the identities unified under a unifying identity.

For example, a user may create logical links between two unifying identities, modify the value of a property of an identity or of a flag thereof, etc.

Once a modification has been made to a unifying identity, the application 302 notifies it to each external reconciliation server connected thereto so that it can update its reconciliation database.

In addition, the reconciliation server 300 can receive notifications of identity modifications from each identity management or reconciliation server connected thereto. These notifications comprise, for example, information relating to modifications made to the identities managed by those servers and, in response, the server 300 updates its reconciliation database 304 in accordance with this information.

For example, if an identity is deleted from a server and reconciled on the server 300, said server 300 deletes this reconciliation.

Advantageously, the application 302 can also delete duplicate unifying identities from the reconciliation database 304 by implementing a similar process to that described in relation to FIGS. 4, 5, 6 and 7 so that only one single unifying identity exists per patient.

1. Method for managing patients' identities in a computer network (10) for producing and storing medical data relating to said patients and referenced on the network (10) by the identities of said patients, characterised in that it comprises:
a search step (100, 102, 104, 106, 108, 110, 112) on the network for identities potentially associated with the same patient;
a validation step (208) of at least one identity found to be effectively associated with said patient;
a step (214) for selecting an identity from among the validated identities; and
a merge step (216) under the selected identity of at least one other validated identity, such that this at least one other merged identity is taken offline, and such that the data relating to this patient previously referenced by this at least one other merged identity are now referenced by the selected identity of said patient.

2. Method according to claim 1, characterised in that the patient's identity comprises a plurality of alphanumeric patient identification fields, and in that the search step comprises:
a selection step (102, 104) of at least one set of identities from the network depending on a first predetermined field and/or a predetermined partition of the network into computer sub- networks;
a step (106) for selecting two identities from the selected set;
a comparison step (110) of these two identities suitable for comparing the values of at least one second field thereof; and
a step (150) for creating a logical relation between these two identities if they have a degree of similarity greater than a predetermined value, this relation defining them as identities that are potentially associated with the same patient.

3. Method according to claim 2, characterised in that the plurality of identification fields for a patient's identity comprises character strings relating respectively to the surname, forename, date of birth and sex of the patient and in that the comparison step of the two identities comprises the implementation of a phonetic-comparison-type algorithm between, on the one hand, the surnames of these two identities, and on the other hand, the forenames of these two identities, and in that:
if the surnames and forenames of these two identities correspond phonetically, and the sex and date of birth thereof are identical, the two identities are then ascertained as having a high degree of similarity;
if only the surnames of these two identities correspond phonetically, and the sex and date of birth thereof are identical, the two identities are then ascertained as having a moderate degree of similarity; and
otherwise, these two identities are ascertained as having a low degree of similarity.

4. Method according to claim 2, characterised in that the plurality of identification fields for a patient's identity comprises character strings relating respectively to the patient's surname and forename, in that the comparison step (110) of the two identities comprises the implementation of a divergence-type algorithm between, on the one hand, the surnames of these two identities, and on the other hand, the forenames of these two identities, to determine a degree of similarity between them depending on the average divergences between the surnames and forenames returned by the divergence-type algorithm.

5. Method according to claim 1, characterised in that it comprises a step (84) for creating a logical link between two identities in the network.

6. Method according to claim 1, characterised in that it comprises a merger cancellation step between two identities on the network, the merged identity being then put back online and the medical data referenced by these identities being restored to their initial state.

7. Method according to claim 1, characterised in that it comprises a search step (82), by a medical operator or external third-party system, for a patient identity on the network by interrogating the value of at least one identification field of the identity.

8. Method according to claim 1, characterised in that a patient's identity on the network comprises a plurality of identification fields distributed in sets of identification fields, in particular an identifier field referencing the patient associated with the identity in a one-to-one manner on the network and properties relating respectively to principal, secondary, complementary and administrative identification data for that identity.

9. Method according to claim 1, characterised in that when an identity in the network is modified, all the computer resources using this identity in the network are notified of this in order to update it on said computer resources.

10. Server (40) for managing patients' identities in a computer network (10) for producing and storing medical data relating to said patients and referenced on the network by the identities of those patients, characterised in that it comprises:
means (50, 56, 64) for searching on the network for identities potentially associated with the same patient;
means (50, 64) for validating a least one identity found to be effectively associated with this patient;
means (50, 64) for selecting an identity from among the validated identities; and
means (64) for merging at least one other validated identity under the selected identity, such that said at least one other merged identity is taken offline, and such that the data relating to this patient previously referenced by said at least one other merged identity are now referenced by the identity selected for this patient.

11. Server for managing patients' identities in a computer network (10) for producing and storing medical data relating to said patients and referenced on the network by the identities of those patients, characterised in that it comprises:
means (50, 56, 64) for searching on the network for identities potentially associated with the same patient;
means (50, 64) for validating a least one identity found to be effectively associated with this patient;
means (50, 64) for selecting an identity from among the validated identities; and
means (64) for merging at least one other validated identity under the selected identity, such that said at least one other merged identity is taken offline, and such that the data relating to this patient previously referenced by said at least one other merged identity are now referenced by the identity selected for this patient,
characterised in that it is suitable for implementing an identity management method.

12. Server according to claim 10, characterised in that it comprises trace storage means (60) for storing data relating to accesses to the server and the functions thereof.

13. Server according to claim 12, characterised in that it comprises means (68) for generating statistics depending on data stored in the means over a predetermined time period in the trace storage means.

14. Server according to claim 10 characterised in that it comprises means (52, 52a) for authenticating a user connected by a terminal.

15. Server according to claim 14, characterised in that it comprises means (52, 52b) for allocating to the user authorisations for a predetermined set of authorisations relating to the use of functions and access to data on the server.

16. Patient identity reconciliation method for a plurality of computer networks (12A, 12B; 12C, 12D) producing and storing medical data relating to said patients, characterised in that it comprises:
a step (400) for creating a unifying identity for a patient identified in the plurality of networks;
a search step (404, 410) on the plurality of networks for identities potentially associated with the same patient;
a step (406; 416) for validating an identity found to be effectively associated with the same patient; and
a step (408; 418) for reconciling the validated identity under the patient's unifying identity.

17. Method according to claim 16, characterised in that it comprises a step for modifying a unifying identity and notifying at least one server from the plurality of networks using the unifying identity that said unifying identity has been modified.

18. Method according to claim 16, characterised in that the search step comprises a step for selecting an identity from the plurality of networks.

19. Method according to claim 16, characterised in that the identities from the plurality of networks are controlled by computer servers, and in that the search step comprises an identity search notification step for each of said servers depending on data relating to the patient stored in the unifying identity.

20. Method according to claim 19, characterised in that the validation step comprises a step for comparing identities delivered by the computer servers in response to the search notification to said servers.

21. Patient identity reconciliation server (300) for a plurality of computer networks (12A, 12B; 12C, 12D) producing and storing medical data relating to said patients, characterised in that it comprises:
means (302) for creating a unifying identity for a patient identified in the plurality of networks;
means (50, 302) for searching on the plurality of networks for identities potentially associated with the same patient;
means (50, 302) for validating an identity found to be effectively associated with this patient; and
means (302) for reconciling the validated identity under the patient's unifying identity.

22. Patient identity reconciliation server (300) for a plurality of computer networks (12A, 12B; 12C, 12D) producing and storing medical data relating to said patients, characterised in that it comprises:
means (302) for creating a unifying identity for a patient identified in the plurality of networks;
means (50, 302) for searching on the plurality of networks for identities potentially associated with the same patient;
means (50, 302) for validating an identity found to be effectively associated with this patient; and
means (302) for reconciling the validated identity under the patient's unifying identity;
characterised in that the reconciliation server is also an identity server according to claim 10 for at least one network of the plurality of networks.
